(19) United States
(12) Patent Application Publication
(10) Pub. No.: US 2025/0360758 A1
(43) Pub. Date: Nov. 27, 2025

(54) Tire for a Heavy Duty Vehicle with Increased Service Life

(71) Applicant: COMPAGNIE GENERALE DES ETABLISSEMENTS MICHELIN, Clermont-Ferrand (FR)

(72) Inventors: Xavier ROBIN, Clermont-Ferrand Cedex 9 (FR); Damien BARDIN, Clermont-Ferrand Cedex 9 (FR)

(21) Appl. No.: 18/874,856

(22) PCT Filed: Jun. 13, 2023
(86) PCT No.: PCT/EP2023/065730

§ 371 Date: Dec. 13, 2024

(30) Foreign Application Priority Data
Jun. 16, 2022 (FR) FR2205879

(51) Int. Cl. B60C 11/03; B60C 11/00

(52) U.S. Cl. CPC B60C 11/0323; B60C 11/005; B60C 2200/06

(57) ABSTRACT

A non-regroovable tire for a heavy-duty vehicle, with an increased service life. The median portion (23) of the tread (2) has at least one cut (22), the latter has a wide radially inner first portion (221) having a height (H1) at least equal to 0.2 times the depth (H) of the cut (22) and a mean width (W1) greater than 2 mm, and a narrow second portion (222) having a height (H2) at least equal to 4 mm and at most equal to the difference between the depth (H) of the cut (22) and the depth (H1) of the wide first portion (221), and a mean width (W2) at most equal to 2 mm, and the minimum thickness (Ei) of the intermediate layer (3), measured between the bottom (220) of the cut and the crown reinforcement (4), is at least equal to 2 mm and at most equal to 4 mm, and satisfies the relationship: Ei³/W1≤12 mm², Ei and W1 being expressed in mm.

The present invention relates to a tire for a heavy-duty vehicle and more particularly to the crown of said tire.

In what follows, the circumferential or longitudinal direction is the direction of rotation of the tire, the axial or transverse direction is the direction parallel to the axis of rotation of the tire and the radial direction is a direction perpendicular to the axis of rotation of the tire.

The crown of a tire comprises, radially from the outside inwards, a tread of rubber material, an intermediate layer also of rubber material, and a crown reinforcement having at least one crown layer comprising reinforcements embedded in a rubber material.

The tread is the peripheral part of the tire that is intended, as it comes into contact with the ground, via a tread surface, to grip the ground and be worn away. It generally comprises a tread pattern, consisting of cuts separating raised elements and therefore delimited by two walls of rubbery material. These cuts may be circumferential, axial or oblique. By convention, with respect to the circumferential direction of the tire, a circumferential cut forms a mean angle at most equal to 30°, an oblique cut forms a mean angle of between 30° and 70° and an axial cut forms a mean angle at least equal to 70°.

The intermediate layer, radially to the inside of the tread and in contact therewith, provides a mechanical connection between the tread and the crown reinforcement. In particular, it protects the crown reinforcement from external attack, and more particularly from mechanical attack generated by foreign bodies penetrating into the tread.

The crown reinforcement comprises at least one crown layer and, most often, a radial superposition of crown layers extending circumferentially, radially to the inside of the intermediate layer and in contact therewith, and radially to the outside of a carcass reinforcement, said carcass reinforcement providing the overall reinforcement of the tire. A crown layer comprises reinforcers, most often metallic in the case of a tire for a heavy-duty vehicle, and coated in a rubber material.

Among the crown layers, a distinction is usually made between the protective layers, which make up a radially outermost protective reinforcement, and the working layers, which make up a working reinforcement comprised radially between the protective reinforcement and the carcass reinforcement. The crown reinforcement may further comprise a hoop reinforcement positioned radially to the inside of the working reinforcement, between two working layers of the working reinforcement, or radially to the outside of the working reinforcement.

The protective reinforcement, comprising at least one protective layer, essentially protects the working reinforcement from mechanical or physicochemical attack, likely to spread through the tread radially toward the inside of the tire. A protective layer generally comprises elastic metal reinforcers, parallel to each other and forming angles at least equal to 10° with the circumferential direction. An elastic metal reinforcer is characterized by a structural elongation As at least equal to 1% and a total elongation at break At at least equal to 4%. Moreover, an elastic metal reinforcer has a tensile elastic modulus at most equal to 150 GPa, and usually comprised between 40 GPa and 150 GPa. These mechanical properties are deduced from a curve representing the tensile force (in N), applied to the metal reinforcement, as a function of its relative elongation (in %), called the force-elongation curve, in accordance with ISO 6892 of 1984.

The working reinforcement, which generally comprises at least two working layers, has the function of belting the tire and of conferring stiffness and roadholding on the tire. It absorbs both the mechanical stresses of inflation, which are generated by the tire inflation pressure and transmitted by the carcass reinforcement, and the mechanical stresses caused by running, which are generated as the tire runs over the ground and are transmitted by the tread. It also needs to withstand oxidation and impacts and puncturing, by virtue of its intrinsic design and that of the protective reinforcement. A working layer usually comprises two inextensible metal reinforcers that are parallel to each other and form angles at most equal to 60°, and preferably at least equal to 15° and at most equal to 45°, with the circumferential direction. An inextensible metal reinforcer is characterized by a total elongation At, under a tensile force equal to 10% of the force at break Fm, at most equal to 0.2%. Moreover, an inextensible metal reinforcer has a tensile elastic modulus usually comprised between 150 GPa and 200 GPa. These mechanical properties are also deduced from a force-elongation curve as described above.

The function of the hooping reinforcement, comprising at least one hooping layer, is to absorb at least part of the mechanical stresses of inflation and therefore to reduce the mechanical stresses of inflation that are transmitted to the working reinforcement. It contributes to a stiffening of the crown reinforcement, which increases the endurance of the crown reinforcement, compared to a crown reinforcement without hooping. A hooping layer comprises metal reinforcers, parallel to each other and forming, with the circumferential direction, angles at most equal to 10°, preferably at most equal to 5° and even more preferably equal to 0°.

The crown of the tire described above is connected at two axial ends to two sidewalls, themselves respectively connected to two beads, said beads providing the mechanical connection between the tire and the rim on which the tire is intended to be mounted.

In a known manner, tires for a heavy-duty vehicle are most often regrooveable. The user effectively has the possibility, after a certain level of wear of the tire, of regrooving it, that is to say of removing, generally manually, a certain thickness of rubber material from the tread, radially toward the inside, starting from the bottom of the circumferential or transverse cuts of the tread. This regrooving operation allows the cuts to be recreated at the end of the life of the tire, which prolongs the service life of the tire.

Such regrooving is still possible if the thickness of rubber material between the bottom of the deepest tread cut and the crown reinforcement is sufficient, typically at least equal to 5 mm. This thickness of rubber material, radially to the inside of the deepest cut, is made up of the superposition of a tread portion thickness and an intermediate layer thickness. To limit the regrooving depth, which is usually comprised between 2 and 4 mm, and in order to leave a sufficient residual thickness of rubber material between the bottom of the recut groove and the crown reinforcement, regrooving indicators are generally installed at the bottom of the cut, to guide the user in their regrooving operation, and to prevent them from cutting too deeply and reaching the crown reinforcement, which would be detrimental to the life of the tire.

However, many users do not make use of this possibility of regrooving, which results in partial exploitation of the wear potential of the tire, and therefore in a non-optimized cost of operating the tire.

The inventors have therefore set themselves the objective of proposing a tire for a heavy-duty vehicle with an increased service life, without resorting to regrooving, while maintaining a satisfactory level of endurance of the crown of the tire.

The invention relates to a tire for a heavy-duty vehicle comprising, radially from the outside towards the inside, a tread, an intermediate layer and a crown reinforcement:
the tread, intended to come into contact with the ground via a tread surface, having an axial width and comprising an arrangement of raised elements made of rubber material and cuts separating them,
the tread comprising a median portion having an axial width at most equal to 80% of the axial width of the tread and separating two lateral portions,
the median portion comprising at least one cut,
the at least one cut having a depth, measured perpendicular to the tread surface, between the tread surface and a bottom of the cut,
the intermediate layer, comprising a rubber material, having a minimum thickness, measured between the bottom of the cut and the crown reinforcement,
the crown reinforcement comprising at least one crown layer comprising reinforcers embedded in a rubber material,
the at least one cut of the median portion having a wide radially inner first portion extending radially outwards from the bottom of the cut, over a height at least equal to 0.2 times the depth of the cut, and having a mean width greater than 2 mm,
the at least one cut of the median portion having a narrow second portion, extending radially outwards from the radially inner first portion over a height at least equal to 4 mm and at most equal to the difference between the depth of the cut and the depth of the wide first portion, and having a mean width at most equal to 2 mm,
the minimum thickness of the intermediate layer, measured between the bottom of the cut and the crown reinforcement, being at least equal to 2 mm and at most equal to 4 mm
and the minimum thickness of the intermediate layer and the mean width of the wide radially inner first portion of the at least one cut of the median portion satisfying the relationship: Ei³/W1≤12 mm², Ei and W1 being expressed in mm.

The invention essentially consists in replacing a possibility of usual regrooving of a tire with a proposal of greater tread depth, and therefore of a higher tread thickness, by reducing the quantity of material available between the bottom of the cut and the crown reinforcement to a minimum thickness comprised between 2 and 4 mm, in order to allow maximum use of the tire without special intervention by the user.

The invention thus proposes, at least in the median portion of the tread, stepped, progressive cuts having a maximized depth and each comprising a wide, radially inner, first portion and a narrow second portion, radially to the outside of the wide first portion. The wide first portion extends, radially outwards, from the bottom of the cut, over a height at least equal to 0.2 times the depth of the cut, and has a mean width greater than 2 mm: it is therefore a groove-like portion. The narrow second portion extends radially outwards from the radially inner first portion over a height at least equal to 4 mm and at most equal to the difference between the depth of the cut and the depth of the wide first portion, and has a mean width at most equal to 2 mm: it is therefore a sipe-type portion that may possibly, but will not necessarily, open onto the tread surface when the tire is new.

Such a stepped progressive cut thus makes it possible to make the bottom of the cut accessible to foreign bodies, such as stones, only after the tread has reached an advanced level of wear, at the end of the life of the tire. This arrangement thus makes it possible to minimize the risks of attack on the bottom of the cut, and consequently of cracking of the underlying intermediate layer, which may occur as a result of prolonged retention of foreign bodies in the cut.

A minimum value for the minimum thickness of the intermediate layer, measured plumb with the bottom of the cut, equal to 2 mm, guarantees satisfactory endurance of the crown reinforcement, since it is not directly exposed to the risks of attack, when the tire becomes fully worn.

A maximum value for the minimum thickness of the intermediate layer, measured plumb with the bottom of the cut, equal to 4 mm, makes it possible to limit the contribution made by the intermediate layer to the mass of the tire.

Also according to the invention, the minimum thickness of the intermediate layer and the mean width of the wide radially inner first portion of the at least one cut of the median portion satisfy the relationship: Ei³/W1≤12 mm², Ei and W1 being expressed in mm.

This relationship defines an optimized design domain linking the minimum thickness of the intermediate layer, measured plumb with the bottom of the cut, and the mean width of the wide radially inner first portion of the cut. The minimum thickness of the intermediate layer determines the protection of the crown reinforcement against external attack. The mean width of the wide radially inner first portion defines the width of the cut for complete tread wear and limits the size of the foreign bodies trapped by the cut and capable of generating cracks at the bottom of the cut.

According to one particular embodiment of the invention, the intermediate layer comprises a median portion separating two lateral portions of said intermediate layer, having an axial width at most equal to the axial width of the median portion of the tread and comprising a rubber material of different chemical composition from those of the rubber materials of the two lateral portions of said intermediate layer.

The median portion of the intermediate layer, positioned radially to the inside of the median portion of the tread, operates at lower temperatures than the lateral portions of the intermediate layer, due to smaller shear deformations, but is exposed to greater risk of attack, due to higher ground contact pressures. Conversely, the lateral portions of the intermediate layer operate at higher temperatures, but are less exposed to attack. It is therefore advantageous to have rubber compounds that are differentiated between the median and lateral portions of the intermediate layer: a rubber material that exhibits greater hysteresis and is more resistant to attack in the median portion of the intermediate layer, and a rubber material that exhibits less hysteresis and is less resistant to attack in the lateral portions of the intermediate layer.

Advantageously, the at least one cut of the median portion has a radially inner first portion extending radially outwards from the bottom of the cut, over a height at most equal to 0.6 times the depth of the cut.

Beyond 0.6 times the depth of the cut, the height of the narrow second portion, extending radially outwards from the radially inner first portion, becomes too small for this second portion to perform the function of blocking the mutually-facing elements of material that delimit it. This blocking effectively makes it possible to limit the deformations of the tread, which, on the one hand, makes it possible to dissipate less energy and to limit the rolling resistance, and, on the other hand, gives the tread a stiffness that is beneficial to the resistance of the tread to wear.

According to one particular embodiment, the at least one cut of the median portion has a wide radially outer third portion, radially to the outside of the narrow second portion, opening onto the tread surface and having a width, measured on the tread surface, at least equal to 2 mm.

In other words, this radially outermost third portion is a groove. Thus, the stepped progressive cut is constituted, radially from the outside toward the inside, by groove, sipe and groove portions, respectively. This arrangement makes it possible to modulate the level of grip on wet ground at different states of tread wear.

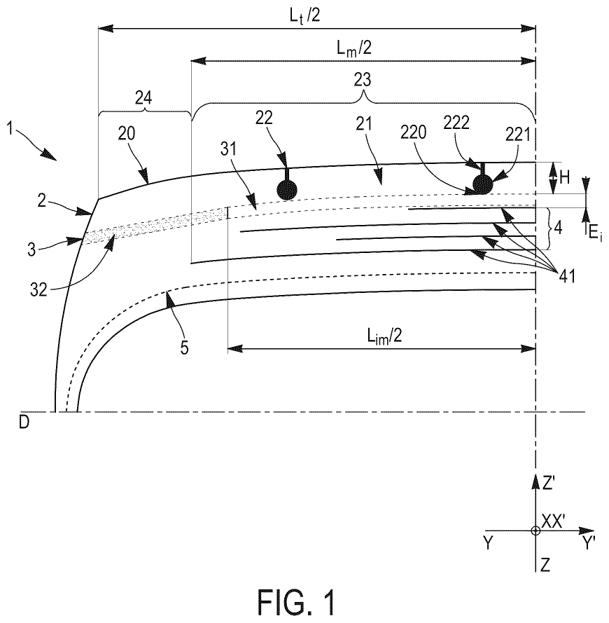

The features of the invention are illustrated by the schematic FIGS. 1 to 5, which are not drawn to scale:

FIG. 1: Partial meridian half-section of a tire according to the invention, with a reduced minimum thickness of the intermediate layer,

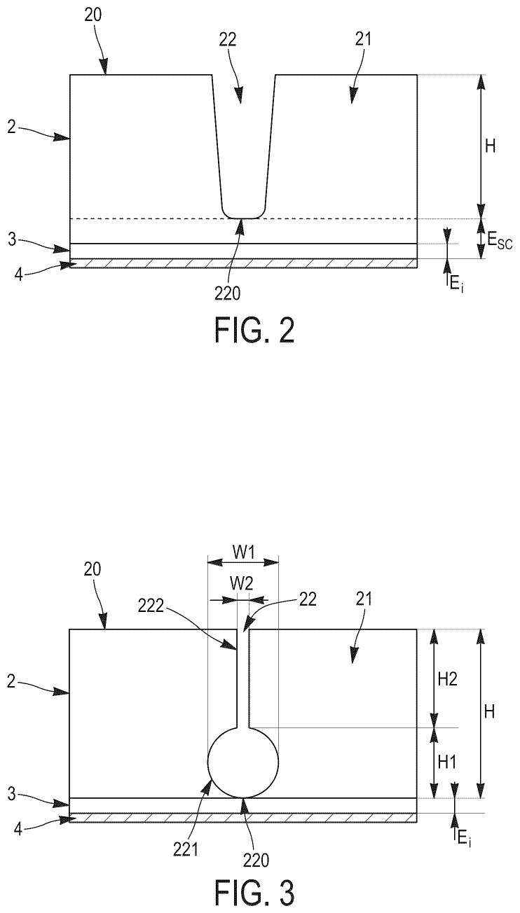

FIG. 2: Cross-sectional view of a cut of a median portion of a tire of the prior art, with a typical minimum thickness of the intermediate layer,

FIG. 3: Cross-sectional view of a stepped progressive cut of a median portion of a tire according to a first embodiment of the invention, with a reduced minimum thickness of the intermediate layer,

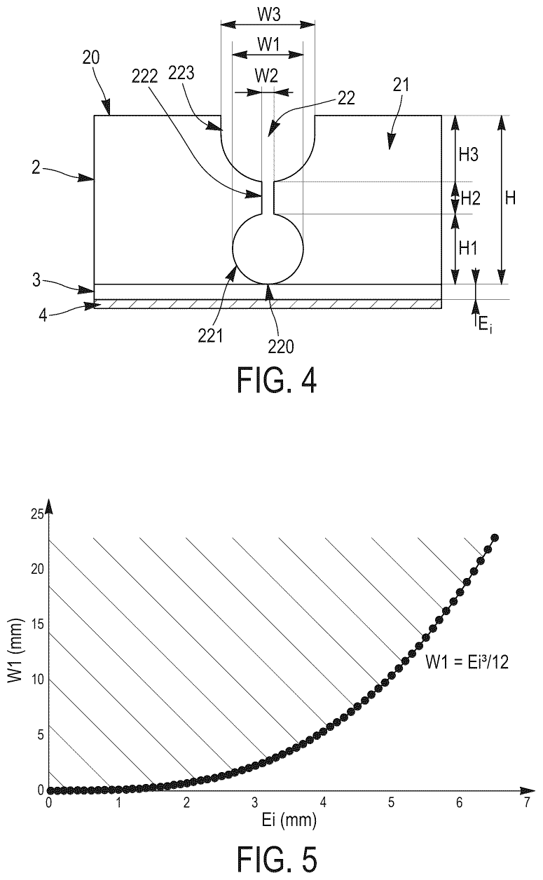

FIG. 4: Cross-sectional view of a stepped progressive cut of the median portion of a tire according to a second embodiment of the invention, with a reduced minimum thickness of the intermediate layer,

FIG. 5: Design range of the invention linking the mean width of the cut, at the end of tread wear, to the minimum thickness of the intermediate layer, plumb with the cut.

FIG. 1 is a partial meridian half-section, in a YZ plane, of a tire according to the invention, with a reduced minimum thickness of the intermediate layer. Consequently, only axial widths divided by 2 are shown in this FIG. 1. Similarly, elements that are symmetrical with respect to the median circumferential plane XZ of the tire are shown only once. This meridian half-section is partial because only the portion radially outside the straight line passing through the greatest axial width of the tire is shown. The tire 1 for a heavy-duty vehicle comprises, radially from the outside toward the inside, a tread 2, an intermediate layer 3 and a crown reinforcement 4. The tread 2, intended to come into contact with the ground via a tread surface 20, has an axial width Lt and comprises an arrangement of raised elements 21 made of rubber material and cuts 22 separating them. The tread 2 comprises a median portion 23 having an axial width Lm at most equal to 80% of the axial width Lt of the tread 2 and separating two lateral portions 24. The median portion 23 comprises four cuts 22, only two of which are shown in the meridian half-section of FIG. 1. Each cut 22 has a depth H, measured perpendicularly to the tread surface 20, between the tread surface 20 and a bottom 220 of the cut. The intermediate layer 3, comprising a rubber material, has a minimum thickness Ei, measured between the bottom 220 of the cut and the crown reinforcement 4. In the embodiment shown, the intermediate layer 3, having a substantially constant thickness Ei, comprises a median portion 31 separating two lateral portions 32 of said intermediate layer 3, having an axial width Lim at most equal to the axial width Lm of the median portion 23 of the tread and comprising a rubber material of chemical composition different from those of the rubber materials of the two lateral portions 32 of said intermediate layer 3. The crown reinforcement 4 comprises four crown layers 41 comprising reinforcers embedded in a rubber material and is constituted, in the embodiment shown, radially from the inside towards the outside, by a first working layer, a hooping layer, a second working layer and a protective layer. The crown reinforcement is radially to the outside of a carcass reinforcement depicted in broken line. According to the invention, each cut 22 of the median portion 23 has a wide radially inner first portion 221, extending radially outwards from the bottom 220 of the cut, and a narrow second portion 222, extending radially outwards from the radially inner first portion 221, and the minimum thickness Ei of the intermediate layer 3, measured between the bottom 220 of the cut and the crown reinforcement 4, is at least equal to 2 mm and at most equal to 4 mm.

FIG. 2 is a cross-sectional view of a cut of a tire of the prior art with a typical minimum thickness of the intermediate layer. The cut 22 in the median portion of the tread 2, delimited by two raised elements 21, has a depth H, measured perpendicularly to the tread surface 20, between the tread surface 20 and a bottom 220 of the cut: this is a simple cut formed by a single cavity. The intermediate layer 3, comprising a rubber material, has a minimum thickness Ei, measured between the bottom 220 of the cut and the crown reinforcement 4. For a tire of the prior art, the usual minimum thickness Ei is generally at least equal to 5 mm, to allow regrooving of the tread when it reaches complete wear.

FIG. 3 is a cross-sectional view of a stepped progressive cut of the median portion of a tire according to a first embodiment of the invention, with a reduced minimum thickness of the intermediate layer. The cut 22 in the median portion of the tread 2, delimited by two raised elements 21, has a depth H, measured perpendicularly to the tread surface 20, between the tread surface 20 and a bottom 220 of the cut. According to this first embodiment of the invention, the cut 22 has a wide radially inner first portion 221 extending radially outwards from the bottom 220 of the cut over a height H1 at least equal to 0.2 times the depth H of the cut 22, and having a mean width W1 greater than 2 mm. In addition, the cut 22 has a narrow second portion 222 extending radially outwardly from the radially inner first portion 221, over a height H2 at least equal to 4 mm and equal to the difference between the depth H of the cut 22 and the depth H1 of the wide first portion 221, and having a mean width W2 at most equal to 2 mm. Finally, the minimum thickness Ei of the intermediate layer 3, measured between the bottom 220 of the cut and the crown reinforcement 4, is at least equal to 2 mm and at most equal to 4 mm. Thus, in this first embodiment of the invention, the stepped progressive cut 22 comprises two stages: a radially inner stage of groove type and a radially outer stage of sipe type, combined with a reduced minimum thickness Ei, measured between the bottom 220 of the cut and the crown reinforcement 4, at least equal to 2 mm and at most equal to 4 mm, which makes it possible, compared with the state of the art, to increase the depth H of the cut 22, typically by 1 mm to 3 mm, so as to increase the thickness of the material to be worn by 1 mm to 3 mm.

FIG. 4 is a cross-sectional view of a stepped progressive cut of the median portion of a tire according to a second embodiment of the invention. This second embodiment differs from the first embodiment by a narrow second portion 222, extending radially outwards from the radially inner first portion 221, over a height H2 strictly less than the difference between the depth H of the cut 22 and the depth H1 of the wide first portion 221, and by a wide radially outer third portion 223, radially to the outside of the narrow second portion 222, opening onto the tread surface 20 and having a width W3, measured on the tread surface 20, at least equal to 2 mm. Thus, in this second embodiment of the invention, the stepped progressive cut 22 comprises three stages: a radially inner groove-type stage, a radially intermediate sipe-type stage and a radially outer groove-type stage. As previously, this stepped progressive cut 22 is combined with a reduced minimum thickness Ei, measured between the bottom 220 of the cut and the crown reinforcement 4, at least equal to 2 mm and at most equal to 4 mm.

FIG. 5 shows a design domain according to the invention linking the mean width W1 of the cut 22, at the end of tread wear, that is to say linking the mean width W1 of the wide first portion 221, to the minimum thickness Ei of the intermediate layer 3, plumb with the cut 22. According to the invention, the following relationship is satisfied: Ei³/W1≤12 mm², Ei and W1 being expressed in mm. The design domain of the invention is the hatched part of the graph.

The inventors have more particularly studied this invention for a tire of dimension 315/80 R22.5, intended to equip a steering axle of a heavy-duty vehicle and having a load capacity of 4000 kg for an inflation pressure equal to 8.5 bar.

Table 1 below shows the characteristics of a 315/80 R 22.5 tire according to the invention (I), compared with those of a reference tire 315/80 R 22.5 Michelin X MULTI

D of the prior art (R):

TABLE 1

| | | | R (315/80 R 22.5 | | Comments on the |
|---|---|---|---|---|---|
| | I (315/80 | | MICHELIN × | | characteristics |
| Characteristics | R 22.5) | | MULTI D) | | of I. |
| Axial width Lt of the tread | 280 | mm | 280 | mm | |
| 2 (mm) | | | | | |
| Axial width Lm of the | 224 | mm | 224 | mm | |
| median portion 23 of the | | | | | |
| tread 2 (mm) | | | | | |
| Depth H of cut 22 (mm) | 18.8 | mm | 17 | mm | H = maximum |
| | | | | | tread height |
| Height H1 of radially inner | 7 | mm | N/A | | H1 >= 0.2H = |
| first portion 221 (mm) | | | | | 3.8 mm |
| Width W1 of radially inner | 6 | mm | N/A | | W1 > 2 mm |
| first portion 221 (mm) | | | | | |
| Height H2 of narrow | 11.8 | mm | N/A | | H2 = H − H1 >= |
| second portion 222 (mm) | | | | | 4 mm |
| Width W2 of the narrow | 1.5 | mm | N/A | | W2 <= 2 mm |
| second portion 222 | | | | | |
| Minimum thickness Ei of | 3.2 | mm | 5 | mm | 2 mm <= Ei <= |
| the intermediate layer 3 | | | | | 4 mm |
| Relationship Ei³/W1 | 5.46 | mm² | 20.8 | mm² | Ei³/W1 <= 12 mm² |

1. A tire for a heavy-duty vehicle comprising, radially from the outside toward the inside, a tread, an intermediate layer and a crown reinforcement:
the tread intended to come into contact with the ground via a tread surface, having an axial width (Lt) and comprising an arrangement of raised elements made of rubber material and cuts separating them,
the tread comprising a median portion having an axial width (Lm) at most equal to 80% of the axial width (Lt) of the tread and separating two lateral portions,
the median portion comprising at least one cut,
at least one cut having a depth (H), measured perpendicular to the tread surface, between the tread surface and a bottom of the cut,
the intermediate layer, comprising a rubber material, having a minimum thickness (Ei), measured between the bottom of the cut and the crown reinforcement,
the crown reinforcement comprising at least one crown layer comprising reinforcers embedded in a rubber material,
wherein the at least one cut of the median portion has a wide radially inner first portion extending radially outwards from the bottom of the cut, over a height (H1) at least equal to 0.2 times the depth (H) of the cut, and having a mean width (W1) greater than 2 mm, wherein the at least one cut of the median portion has a narrow second portion, extending radially outwards from the radially inner first portion over a height (H2) at least equal to 4 mm and at most equal to the difference between the depth (H) of the cut and the depth (H1) of the wide first portion, and having a mean width (W2) at most equal to 2 mm, wherein has the minimum thickness (Ei) of the intermediate layer, measured between the bottom of the cut and the crown reinforcement, is at least equal to 2 mm and at most equal to 4 mm and wherein the minimum thickness (Ei) of the intermediate layer and the mean width (W1) of the wide radially inner first portion of the at least one cut of the median portion satisfy the relationship: Ei³/W1≤12 mm², Ei and W1 being expressed in mm.

2. The tire according to claim 1, wherein the intermediate layer comprises a median portion separating two lateral portions of said intermediate layer, having an axial width (Lim) at most equal to the axial width (Lm) of the median portion of the tread and comprising a rubber material of different chemical composition from those of the rubber materials of the two lateral portions of said intermediate layer.

3. The tire according to claim 1, wherein the at least one cut (22) of the median portion has a radially inner first portion extending radially outwards from the bottom (220) of the cut, over a height (H1) at most equal to 0.6 times the depth (H) of the cut.

4. The tire according to claim 1, wherein the at least one cut of the median portion has a wide radially outer third portion, radially to the outside of the narrow second portion, opening onto the tread surface and having a width (W3), measured on the tread surface, at least equal to 2 mm.

5. The tire according to claim 2, wherein the at least one cut of the median portion has a radially inner first portion extending radially outwards from the bottom of the cut, over a height (H1) at most equal to 0.6 times the depth (H) of the cut.

6. The tire according to claim 2, wherein the at least one cut of the median portion has a wide radially outer third portion, radially to the outside of the narrow second portion, opening onto the tread surface and having a width (W3), measured on the tread surface, at least equal to 2 mm.

7. The tire according to claim 3, wherein the at least one cut of the median portion has a wide radially outer third portion, radially to the outside of the narrow second portion, opening onto the tread surface and having a width (W3), measured on the tread surface, at least equal to 2 mm.
